(19) United States
(12) Patent Application Publication
(10) Pub. No.: US 2026/0332353 A1
(43) Pub. Date: Oct. 22, 2026

(54) METHODS, APPARATUS AND SYSTEMS OF COMMUNICATION

(71) Applicant: Huawei Technologies Co., Ltd., Shenzhen (CN)

(72) Inventors: Haoyuan Wei, Stittsville (CA); Yu Cao, Ottawa (CA); Van Hung Vu, Ottawa (CA); Huazi Zhang, Hangzhou (CN)

(21) Appl. No.: 19/699,944

(22) Filed: Jun. 5, 2026

Related U.S. Application Data
(63) Continuation of application No. PCT/CN2024/091733, filed on May 8, 2024.
(60) Provisional application No. 63/606,697, filed on Dec. 6, 2023.

(51) Int. Cl. H04L 5/00

(52) U.S. Cl. CPC H04L 5/0053

(57) ABSTRACT

Methods, apparatus, and systems of communication are disclosed. An example method includes obtaining N coded bits, where N is a positive integer. The method further includes obtaining a first bit set that includes at least one information bit; and determining C target code blocks (CBs) according to the N coded bits and the first bit set. The C target CBs include M coded bits from the N coded bits and one or more bits from the first bit set. M is a positive integer less than or equal to N. C is an integer greater than 1. The method further includes transmitting the C target CBs.

### CROSS-REFERENCE TO RELATED APPLICATION

The present application is a continuation of International Patent Application No. PCT/CN2024/091733, filed on May 8, 2024, which claims priority to and the benefit of U.S. Provisional Patent Application Ser. No. 63/606,697, entitled “MIXED-TRAFFIC INTRA-UE MULTIPLE-ACCESS CODING FOR MULTIPLE CBS,” and filed on Dec. 6, 2023. The entire contents of the aforementioned applications are hereby incorporated by reference.

### TECHNICAL FIELD

The present application relates to coding for wireless communications, and in particular to coding of combined payloads from mixed traffic.

### BACKGROUND

Channel coding is a procedure to transform a sequence of information bits into a longer sequence of transmitted bits to make the transmission more robust to disturbances. Systematic low-density parity check (LDPC) codes, for example, employ an encoding procedure that generates a number of parity-check bits from information bits. After encoding, the obtained sequence is called coded bits of the mother code. A rate matching procedure follows to select a desired number of coded bits for transmission, in order to meet a code rate requirement of the communication system.

A user equipment (UE) may handle different traffic with different quality of service (QoS) requirement. For example, ultra-reliable low latency communications (URLLC) traffic may require block error rate (BLER) of 0.00001, while enhanced mobile broadband (eMBB) traffic may only require BLER of 0.1. Moreover, a latency requirement of URLLC may be 1 ms, or possibly even more strict in the future. Such requirements mean that URLLC traffic may barely have a chance for retransmission. It is generally desirable for a UE to effectively take advantage of multiple traffic, and especially to enhance the performance of higher priority traffic such as URLLC.

### SUMMARY

This application provides methods, apparatus, systems, computer-readable storage media, and computer program products of communication, to reduce the effect of embedding operation on the transmission of lower priority traffic, in the case of embedding bits of higher priority traffic into the lower priority traffic.

In some aspects of this application, multiple downlink traffic to the same UE is multiplexed. The performance of higher priority traffic is enhanced with or without performance loss of lower priority traffic. In some aspects of this application, a transport block (TB) of lower priority traffic is segmented into multiple code blocks (CBs). Then higher priority traffic may be multiplexed into multiple CBs to either reduce the performance loss of lower priority traffic while keeping the same performance enhancement for the higher priority traffic or further enhance the performance of the higher priority traffic with the same performance loss of the lower priority traffic.

Higher priority traffic, such as URLLC, is first encoded separately to generate a mother codeword, and some of the coded bits of the mother codeword are selected by a bit-selection module and mixed with lower priority traffic, such as eMBB, by a bit-mixing module, to generate a combined payload. The size of the combined payload may exceed the maximum size of a CB. Then the combined payload is segmented into several CBs. Each CB is encoded separately, and the generated coded bits are passed to a rate-matching module which will select bits to be transmitted depending on a desired code rate and on an eMBB performance tolerance. The final transmission sequence is the concatenation of all sequence out of the rate-matching module.

In a first aspect, an embodiment of this application provides a method of communication, the implementer of the method, i.e., a sender, may be a terminal, a network device, or a chip applied to a terminal or a network device. The method comprises: obtaining N coded bit, wherein N is a positive integer; obtaining a first bit set, wherein the first bit set comprises at least one information bit; determining C target code blocks (CBs), according to the N coded bit and the first bit set, wherein, the C target CBs comprise M coded bit from the N coded bit and bits from the first bit set, M is a positive integer less than or equal to N, C is an integer greater than 1.

The N coded bit may be one or more bits coded by a coding mothed, such as an LDPC code, and it may correspond to one or more traffic, such as URLLC. The first bit set may also correspond to one or more traffic, such as eMBB. The N coded bit may be a whole mother codeword. To improve the performance of transmission, all or part of the N coded bit, such as R coded bit, will be transmitted independently, and all or part of the N coded bit, such as M coded bit, need to be embedded into the first bit set for retransmission. In some cases, the size of bits after embedding may exceed the maximum size of a CB, which may cause part of bits after embedding being dropped or punctured. In the present implementation, bits after embedding are divided into several sets, i.e., the C target CBs, thus, the probability that the size of a target CB exceeds the maximum size of a CB can be reduced, so that the effect of embedding (or combining) operation on the transmission of the first bit set can be reduced without affecting the retransmission of the M coded bit.

In an optional implementation of the first aspect, the method further comprises: determining the M coded bit from the N coded bit, wherein M is an integer greater than 1.

In the present implementation, M is an integer greater than 1, which means more than one coded bit is embedded into the first bit set, thus, more of the N coded bit are retransmitted to enhance the reliability of transmission of the N coded bit.

In an optional implementation of the first aspect, the M coded bit comprises C bit sets, any one of the C bit sets comprises M/C bit.

The C bit sets may be C bit sequences, C bit blocks, or C bit groups, there is no restriction for the form of the C bit sets. By dividing the M coded bit equally, each target CB comprises less embedded bits, so that the effect of embedding operation on the transmission of the first bit set can be reduced.

In an optional implementation of the first aspect, the N coded bit is a first bit sequence, the M coded bit comprises C bit sequences, the start point of any one of the C bit sequences is a start point of a redundancy version of the first bit sequence.

In the present implementation, the C bit sequences correspond to C redundancy versions (RVs), the C RVs can be jointly decoded at a receiver to obtain a better decoding gain.

In an optional implementation of the first aspect, the N coded bit comprises S coded bit sets, S is an integer greater than 1, the method further comprises: determining S bit subsets from the S coded bit sets, the S bit subsets comprise the M coded bit, wherein M is an integer greater than 1.

The S coded bit sets may be S bit sequences, S bit blocks, or S bit groups, there is no restriction for the form of the S coded bit sets. In the present implementation, M is an integer greater than 1, which means more than one coded bit is embedded into the first bit set, thus, more of the N coded bit are retransmitted to enhance the reliability of transmission of the N coded bit.

In an optional implementation of the first aspect, any one of the S bit subsets comprises M/S bit.

By extracting the same number of bits from each of the S coded bit sets, any one of the S bit subsets comprises the same number of bits, so that the transmission reliability of each bit subset will not differ too much.

In an optional implementation of the first aspect, the S coded bit sets are S second bit sequences, the S bit subsets are S bit subsequences, the start point of any one of the S bit subsequences is a start point of a redundancy version of a second bit sequence.

In the present implementation, the S bit subsequences correspond to S RVs, which means that, any two of the S RVs may come from different mother codewords, or some of the S RVs may come from the same mother codeword. Each of the S RVs can be jointly decoded with other RVs corresponding to the same mother codeword (or the same second bit sequence) at a receiver, to obtain a better decoding gain.

In an optional implementation of the first aspect, the S bit subsets correspond to the S coded bit sets one to one.

As an example, the S bit subsets correspond to the S coded bit sets one to one means extracting one or more bits from each of the S coded bit sets, thus, each of the S coded bit sets has a chance to be retransmitted, so that the transmission reliability of some coded bit sets will not be too low.

In an optional implementation of the first aspect, the S coded bit sets are S CBs, and the concatenation of the S CBs is the N coded bit.

In an optional implementation of the first aspect, the determining C target CBS, according to the N coded bit and the first bit set, comprises: determining a third bit sequence, according to the N coded bit and the first bit set, the third bit sequence comprises the M coded bit and bits from the first bit set; determining the C target CBs, by dividing the third bit sequence.

The third bit sequence is obtained by embedding M coded bits into the first bit set or combining M coded bits with the first bit set, after that, the third bit sequence is divided into C target CBs, thus, the probability that the size of a target CB exceeds the maximum size of a CB can be reduced, so that the effect of embedding operation or combining operation on the transmission of the first bit set can be reduced without affecting the retransmission of the M coded bit.

In an optional implementation of the first aspect, the determining a third bit sequence, comprises: determining the third bit sequence, by an interleaver.

The interleaver may be a pseudo-random interleaver. By using an interleaver, the way to determine the third bit sequence is simplified.

In an optional implementation of the first aspect, the determining a third bit sequence, according to the N coded bit and the first bit set, comprises: determining C bit sets, according to the M coded bit, wherein the C bit sets comprise the M coded bit, wherein M is an integer greater than 1; determining the third bit sequence, by inserting the C bit sets into the first bit set.

C could be calculated according to the sum of the number of the M coded bit and the number of bits in the first bit set, so the M coded bit could be divided into C bit sets in advance, and then be inserted into the first bit set.

In an optional implementation of the first aspect, C is proportional to B, and C is inversely proportional to K_{cb}−L, wherein B is the sum of the number of the M coded bit and the number of bits in the first bit set, K_{cb} is the maximum size of a CB, L is the number of bits except for information bits and embedded bits in a CB.

In an optional implementation of the first aspect, the C is proportional to B, and C is inversely proportional to K_{cb}−L, comprises: C=B/(K_{cb}−L).

In an optional implementation of the first aspect, the determining C target CBS, according to the N coded bit and the first bit set, comprises: dividing the first bit set into C CBs; determining C bit sets, according to the M coded bit, wherein the C bit sets comprise the M coded bit, wherein M is an integer greater than 1; determining the C target CBs, by combining the C bit sets and the C CBs.

C could be calculated according to the sum of the number of the M coded bit and the number of bits in the first bit set, so the first bit set could be divided into C CBs in advance, and the M coded bit could also be divided into C bit sets in advance, then the C CBs could be combined with the C bit sets to generate the C target CBs.

In an optional implementation of the first aspect, any one of the C bit sets combines with any one of the C CBs.

By combining each bit set of the C bit sets with each CB of the C CBs, any one of the C target CBs will not comprise too many coded bits, so that the transmission reliability of each CB of the C CBs will not differ too much.

In an optional implementation of the first aspect, C is proportional to B, and C is inversely proportional to K_{cb}−L−P, wherein B is the number of bits in the first bit set, K_{cb} is the maximum size of a CB, L is the number of bit except for information bits and embedded bits in a CB, P is the number of bits which are embedded in a CB.

In an optional implementation of the first aspect, the C is proportional to B, and C is inversely proportional to K_{cb}−L−P, comprises: C=B/(K_{cb}−L−P).

In an optional implementation of the first aspect, the bit except for information bits and embedded bits in a CB is a cyclic redundancy check (CRC).

In an optional implementation of the first aspect, the first 2Z bits of any one of the C target CBs are 2Z information bits from the first bit set, wherein Z is the lifting size of a code which is used for encoding the C target CBs.

The first 2Z bits of a CB may be punctured, by placing the N coded bit beyond the first 2Z bits, the transmission reliability of the N coded bit could be enhanced.

In an optional implementation of the first aspect, the size of any one of the C target CBs is less than or equal to the maximum size of a CB.

In an optional implementation of the first aspect, the N coded bit corresponds to at least two traffic, wherein N is an integer greater than 1.

In an optional implementation of the first aspect, the priority of the N coded bit is higher than the priority of the first bit set.

In an optional implementation of the first aspect, the method further comprises: sending the C target CBS.

In an optional implementation of the first aspect, the method further comprises: sending R coded bit, wherein the R coded bit is all or part of the N coded bit, R is a positive integer less than or equal to N.

In a second aspect, an embodiment of this application provides a method of communication, the implementer of the method, i.e., a receiver, may be a terminal, a network device, or a chip applied to a terminal or a network device. The method comprises: obtaining R coded bit, R is a positive integer; determining N coded bit according to the R coded bit by the coding property, N is a positive integer; obtaining C target code blocks (CBs), C is an integer greater than 1; determining M coded bit and a first bit set from the C target CBs, wherein the N coded bit comprises the M coded bit, the first bit set comprises at least one information bit.

The N coded bit may be one or more bits coded by a coding mothed, such as an LDPC code, and it may correspond to one or more traffic, such as URLLC. The first bit set may also correspond to one or more traffic, such as eMBB. The N coded bit may be a whole mother codeword. To improve the performance of transmission, all or part of the N coded bit, such as R coded bit, will be transmitted independently, and all or part of the N coded bit, such as M coded bit, need to be embedded into the first bit set for retransmission, wherein the R coded bit may be obtained by processing of physical layer, the N coded bit may be determined by jointly decoding of the R coded bit and other RVs corresponding to the same mother codeword. In some cases, the size of bits after embedding may exceed the maximum size of a CB, which may cause part of bits after embedding being dropped or punctured. In the present implementation, bits after embedding are divided into several sets, i.e., the C target CBs, thus, the probability that the size of a target CB exceeds the maximum size of a CB can be reduced, so that the effect of embedding (or combining) operation on the transmission of the first bit set can be reduced without affecting the retransmission of the M coded bit.

In an optional implementation of the second aspect, the M coded bit comprises C bit sets, any one of the C bit sets comprises M/C bit.

The C bit sets may be C bit sequences, C bit blocks, or C bit groups, there is no restriction for the form of the C bit sets. By dividing the M coded bit equally, each target CB comprises less embedded bits, so that the effect of embedding operation on the transmission of the first bit set can be reduced.

In an optional implementation of the second aspect, the N coded bit is a first bit sequence, the M coded bit comprises C bit sequences, the start point of any one of the C bit sequences is a start point of a redundancy version of the first bit sequence.

In the present implementation, the C bit sequences correspond to CRVs, the CRVs can be jointly decoded at a receiver to obtain a better decoding gain.

In an optional implementation of the second aspect, the N coded bit comprises S coded bit sets, the S coded bit sets comprise S bit subsets, the S bit subsets comprise the M coded bit, wherein S is an integer greater than 1, M is an integer greater than 1.

The S coded bit sets may be S bit sequences, S bit blocks, or S bit groups, there is no restriction for the form of the S coded bit sets. In the present implementation, M is an integer greater than 1, which means more than one coded bit is embedded into the first bit set, thus, more of the N coded bit are retransmitted to enhance the reliability of transmission of the N coded bit.

In an optional implementation of the second aspect, any one of the S bit subsets comprises M/S bit.

By extracting the same number of bits from each of the S coded bit sets, any one of the S bit subsets comprises the same number of bits, so that the transmission reliability of each bit subset will not differ too much.

In an optional implementation of the second aspect, the S coded bit sets are S second bit sequences, the S bit subsets are S bit subsequences, the start point of any one of the S bit subsequences is a start point of a redundancy version of a second bit sequence.

In the present implementation, the S bit subsequences correspond to S RVs, which means that, any two of the S RVs may come from different mother codewords, or some of the S RVs may come from the same mother codeword. Each of the S RVs can be jointly decoded with other RVs corresponding to the same mother codeword (or the same second bit sequence) at a receiver, to obtain a better decoding gain.

In an optional implementation of the second aspect, the S bit subsets correspond to the S coded bit sets one to one.

As an example, the S bit subsets correspond to the S coded bit sets one to one means extracting one or more bits from each of the S coded bit sets, thus, each of the S coded bit sets has a chance to be retransmitted, so that the transmission reliability of some coded bit sets will not be too low.

In an optional implementation of the second aspect, the S coded bit sets are S CBS, and the concatenation of the S CBs is the N coded bit.

In an optional implementation of the second aspect, the M coded bit comprises C bit sets, the C bit sets are embedded in the first bit set.

C could be calculated according to the sum of the number of the M coded bit and the number of bits in the first bit set, so the M coded bit could be divided into C bit sets in advance, and then be inserted into the first bit set.

In an optional implementation of the second aspect, C is proportional to B, and C is inversely proportional to K_{cb}−L, wherein B is the sum of the number of the M coded bit and the number of bits in the first bit set, K_{cb} is the maximum size of a CB, L is the number of bits except for information bits in a CB.

In an optional implementation of the second aspect, the C is proportional to B, and C is inversely proportional to K_{cb}−L, comprises: C=B/(K_{cb}−L).

In an optional implementation of the second aspect, the first bit set comprises C CBs, the M coded bit comprises C bit sets, the C CBs are combined with the C bit sets.

C could be calculated according to the sum of the number of the M coded bit and the number of bits in the first bit set, so the first bit set could be divided into C CBs in advance, and the M coded bit could also be divided into C bit sets in advance, then the C CBs could be combined with the C bit sets to generate the C target CBs.

In an optional implementation of the second aspect, any one of the C bit sets combines with any one of the C CBs.

By combining each bit set of the C bit sets with each CB of the C CBs, any one of the C target CBs will not comprise too many coded bits, so that the transmission reliability of each CB of the C CBs will not differ too much.

In an optional implementation of the second aspect, C is inversely proportional to B, and C is inversely proportional to K_{cb}−L−P, wherein B is the number of bits in the first bit set, K_{cb} is the maximum size of a CB, L is the number of bit except for information bits and embedded bits in a CB, P is the number of bits which are embedded in a CB.

In an optional implementation of the second aspect, the C is proportional to B, and C is inversely proportional to K_{cb}−L−P, comprises: C=B/(K_{cb}−L−P).

In an optional implementation of the second aspect, the bit except for information bits and embedded bits in a CB is a CRC.

In an optional implementation of the second aspect, the first 2Z bits of any one of the C target CBs are 2Z information bits from the first bit set, wherein Z is the lifting size of a code which is used for encoding the C target CBs.

The first 2Z bits of a CB may be punctured, by placing the N coded bit beyond the first 2Z bits, the transmission reliability of the N coded bit could be enhanced.

In an optional implementation of the second aspect, the size of any one of the C target CBs is less than or equal to the maximum size of a CB.

In an optional implementation of the second aspect, the N coded bit corresponds to at least two traffic, wherein N is an integer greater than 1.

In an optional implementation of the second aspect, the priority of the N coded bit is higher than the priority of the first bit set.

In a third aspect, an embodiment of this application provides an apparatus of communication, the apparatus is configured to perform any method provided in the first aspect.

In a possible design, the apparatus may be divided into functional modules according to any method provided in the first aspect, each functional module may be obtained through division based on a corresponding function, or two or more functions may be integrated into one module.

For example, the apparatus may be divided into a sending module, a processing module, and the like based on functions. For descriptions of possible technical solutions and beneficial effects performed by the functional modules obtained through division, refer to: the methods provided in the first aspect and the optional implementations thereof.

In a fourth aspect, an embodiment of this application provides an apparatus of communication, the apparatus is configured to perform any method provided in the second aspect.

In a possible design, the apparatus may be divided into functional modules according to any method provided in the second aspect, each functional module may be obtained through division based on a corresponding function, or two or more functions may be integrated into one module.

For example, the apparatus may be divided into a sending module, a processing module, and the like based on functions. For descriptions of possible technical solutions and beneficial effects performed by the functional modules obtained through division, refer to: the methods provided in the second aspect and the optional implementations thereof.

In a fifth aspect, an embodiment of this application provides an apparatus of communication, the apparatus may be a terminal or base station (BS), or the apparatus may be a chip applied to a terminal or BS. The apparatus may comprise a processor, which is used to perform: any method provided in the first aspect and the optional implementations thereof.

Optionally, the apparatus may also comprise a transceiver. When the apparatus is a terminal or BS, the transceiver may be a transceiver circuit, an antenna, etc. When the apparatus is a chip applied to a terminal or BS, the transceiver may be an input/output interface, pin, circuit, etc.

Optionally, the apparatus may also comprise a memory for storing a computer program or instructions, and the processor executes the computer program or instructions stored in the memory to enable the apparatus to perform: any method provided in the first aspect and the optional implementations thereof. When the apparatus is a terminal or BS, the memory may be a read-only memory, random access memory, etc. When the apparatus is a chip applied to a terminal or BS, the memory may be a register, cache, etc.

In a sixth aspect, an embodiment of this application provides an apparatus of communication, the apparatus may be a terminal or BS, or the apparatus may be a chip applied to a terminal or BS. The apparatus may comprise a processor, which is used to perform: any method provided in the second aspect and the optional implementations thereof.

Optionally, the apparatus may also comprise a transceiver. When the apparatus is a terminal or BS, the transceiver may be a transceiver circuit, an antenna, etc. When the apparatus is a chip applied to a terminal or BS, the transceiver may be an input/output interface, pin, circuit, etc.

Optionally, the apparatus may also comprise a memory for storing a computer program or instructions, and the processor executes the computer program or instructions stored in the memory to enable the apparatus to perform: any method provided in the second aspect and the optional implementations thereof. When the apparatus is a terminal or BS, the memory may be a read-only memory, random access memory, etc. When the apparatus is a chip applied to a terminal or BS, the memory may be a register, cache, etc.

In a seventh aspect, an embodiment of this application provides a system of communication, the system comprises: the apparatus provided in the third aspect and the apparatus provided in the fourth aspect, or the apparatus provided in the fifth aspect and the apparatus provided in the sixth aspect.

For example, the system is a communication system, comprising at least one terminal and at least one BS.

For another example, the system is a chip system, comprising at least one processor applied in a terminal and at least one processor applied in a BS.

In an eighth aspect, an embodiment of this application provides a computer-readable storage medium, for example, a non-transitory computer-readable storage medium. The computer-readable storage medium stores a computer program or instructions. When the computer program or instructions runs on an apparatus, the apparatus is enabled to perform: any method provided in the first aspect and the optional implementations thereof, or any method provided in the second aspect and the optional implementations thereof.

In a ninth aspect, an embodiment of this application provides a computer program product, the computer program product comprises computer program code or computer program instructions, when the computer program code or the computer program instructions executed by an apparatus, the apparatus is enabled to perform: any method provided in the first aspect and the optional implementations thereof, or any method provided in the second aspect and the optional implementations thereof.

The apparatus, the system, the computer-readable storage medium, and the computer program product provided in embodiments of this application are all configured to perform the corresponding method provided above. Therefore, for advantageous effects that may be achieved by the apparatus, the system, the computer-readable storage medium, and the computer program product, refer to the advantageous effects of the corresponding method provided above. Details are not described herein again.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system;

FIG. 2 is a block diagram illustration of the example communication system in FIG. 1;

FIG. 3 illustrates an example electronic device and examples of base stations;

FIG. 4 illustrates units or modules in a device;

FIG. 5 illustrates an example joint coding method;

FIG. 6 illustrates another example joint coding method;

FIG. 7 illustrates another example joint coding method;

FIG. 8 illustrates an example apparatus of a sender;

FIG. 9 illustrates an example method performed by a bits-mixing module;

FIG. 10 illustrates another example method performed by a bits-mixing module;

FIG. 11 illustrates another example method performed by a bits-mixing module;

FIG. 12 is a schematic diagram illustrating a more general method of communication according to embodiments;

FIG. 13 is a schematic diagram of structures of a communication apparatus;

FIG. 14 is another schematic diagram of structure of a communication apparatus.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

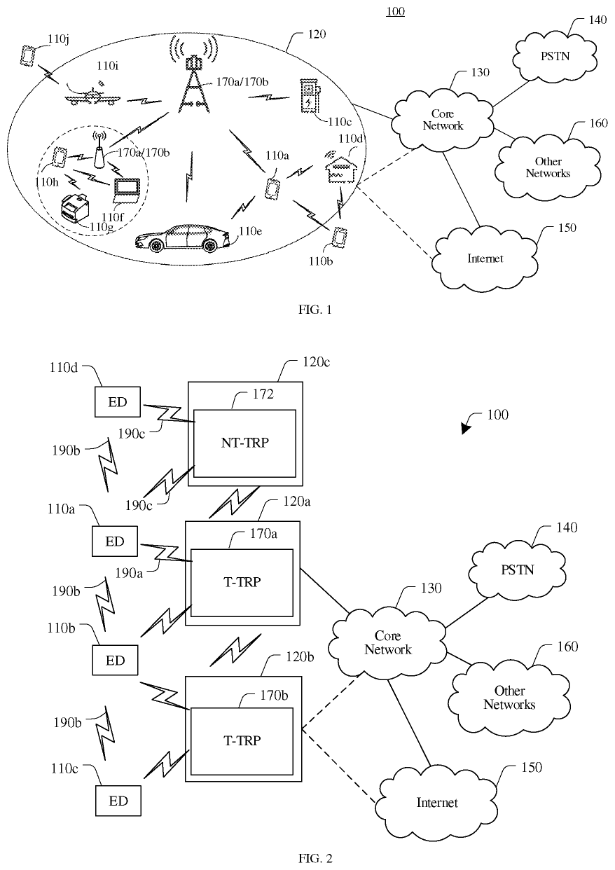

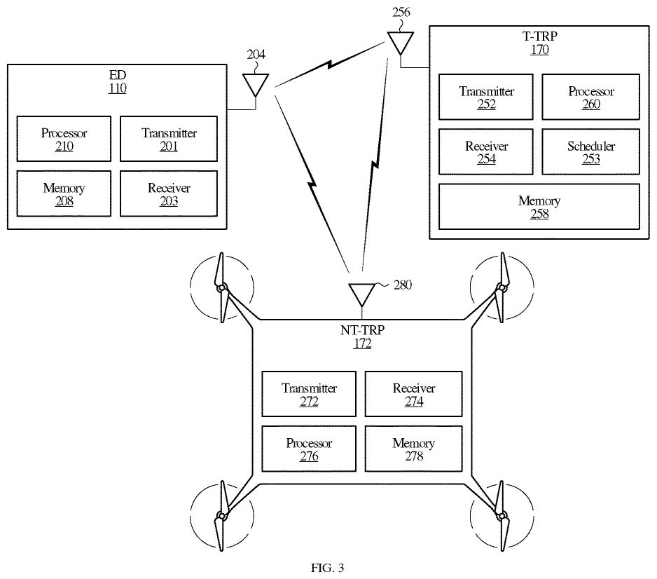

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

FIG. 3 illustrates another example of an ED 110 and a base station 170a, 170b and/or 170c. The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

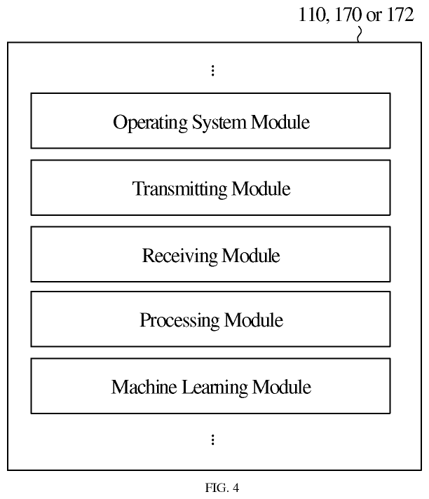

One or more steps of the embodiment methods provided herein may be performed by corresponding units or modules, according to FIG. 4. FIG. 4 illustrates units or modules in a device, such as in the ED 110, in the T-TRP 170, or in the NT-TRP 172. For example, a signal may be transmitted or output by a transmitting unit or by a transmitting module. A signal may be received or input by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

While not shown, the transmitting module and the receiving module may be part of, or combined into, a transceiver module. A transceiver module may also be known as an interface module, or simply an interface, for inputting and outputting operations.

Additional details regarding the EDs 110, the T-TRP 170, and the NT-TRP 172 are known to those of skill in the art. As such, these details are omitted here.

In conventional communications, the different traffic are treated separately and MCS for each traffic is selected based on the traffic's respective QoS requirement. Hybrid automatic repeat request (HARQ) may be used to improve reliability of the communications. However, the round-trip delay incurred by the “NACK” signaling, re-scheduling, and retransmission may cause such communications to not meet expected ultra-latency requirements in future communication systems.

In the context of HARQ, ACK refers to acknowledgement, and NACK refers to negative acknowledgement.

An example joint coding method maps different payloads according to their priorities and encodes them into a long code word.

FIG. 5 illustrates such a joint coding method. As shown, there are x applications (APPs) in a sender, each APP generates data with QoS. For example, APP₁ and APPₓ₋₁ generate data with high QoS, such as URLLC payload, APP₂ and APPₓ generate data with low QoS, such as eMBB payload. Then the URLLC payload and the eMBB payload are encoded by one or more coding methods, such as a CRC encoding, which adds CRC bits after the URLLC payload or the eMBB payload. After the CRC encoding, the URLLC payload and the eMBB payload are mapped to a CB based on priority of payload, wherein, the URLLC payload is mapped to high-priority bits and the eMBB payload is mapped to low-priority bits. Then the bits are jointly encoded into a code word in the channel coding procedure. This provides the desired feature of “unequal error protection (UEP)” to support various reliability requirements in one FEC.

In some implementations of this example method, the BLER of URLLC can be over two orders of magnitudes lower than that of eMBB. As such, joint coding can deliver multiple QoS to multiple services within only one wireless link. However, the log-likelihood ratios (LLRs) corresponding to the entire code word must be received before the decoding can be started. For example, if a URLLC payload with 50 bits and an eMBB payload with 8000 bits are jointly encoded into a code word of 23000 bits. The decoding cannot begin until all 23000 LLRs are received. This will also incur extra delay.

Another example joint coding method embeds/mixes a higher priority payload to a lower priority payload and the two payloads are encoded separately. These embedding bits are transmitted inside two payloads, providing a similar effect of retransmission gain for the higher priority payload.

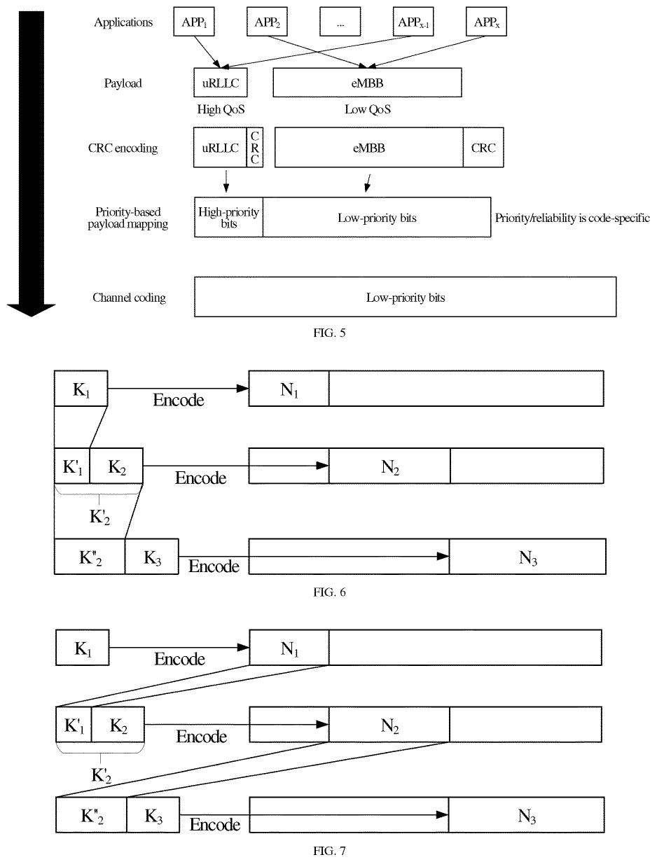

FIG. 6 illustrates such a joint coding method. As shown, K₁ denotes a higher priority payload, K₁ is encoded into N₁ and then transmitted in an initial transmission. K₁′ denotes part or all bits of K₁, while K₂ denotes a lower priority payload, K₁′ and K₂ are combined as K₂′, K₂′ is encoded into N₂ and then transmitted. After that, K₂″, which denotes part or all bits of K₁′, is combined with Kg and then encoded into N₃, wherein K₃ denotes another lower priority payload. N₃ is transmitted in the following transmission.

Therefore, if the higher priority payload is not decoded successfully, it can be decoded again by decoding the lower priority payload instead of directly asking for a retransmission. However, only information bits from the payload are allowed to be mixed, which means the same bits are transmitted twice and the retransmission opportunity is not fully utilized.

Another example joint coding method embeds/mixes coded bits of a higher priority payload to a lower priority payload and the two payloads are encoded separately. These embedding bits are not limited to information bits. Incremental redundancy coded bits can also be embedded into lower priority payload, which may provide a larger performance improvement than transmitting the same information bits twice.

FIG. 7 illustrates such a joint coding method. As shown, K₁ denotes a higher priority payload, K₁ is encoded into N₁ and then transmitted in an initial transmission. K₁′ denotes part or all bits of N₁, while K₂ denotes a lower priority payload, K₁′ and K₂ are combined as K₂′, K₂′ is encoded into N₂ and then transmitted. After that, K₂″, which denotes part or all bits of N₂, is combined with K₃ and then encoded into N₃, wherein K₃ denotes another lower priority payload. N₃ is transmitted in the following transmission.

However, FIG. 7 doesn't consider the size of embedding bits and lower priority payload, which means the size of K₂″ and Kg or the size of K₂′ may exceed the maximum size of a CB. Therefore, bits with higher priority, such as K₁′ and K₂″, may be dropped or punctured after encoding.

With reference to the accompanying drawings, the following describes the technical solutions provided in embodiments of this application.

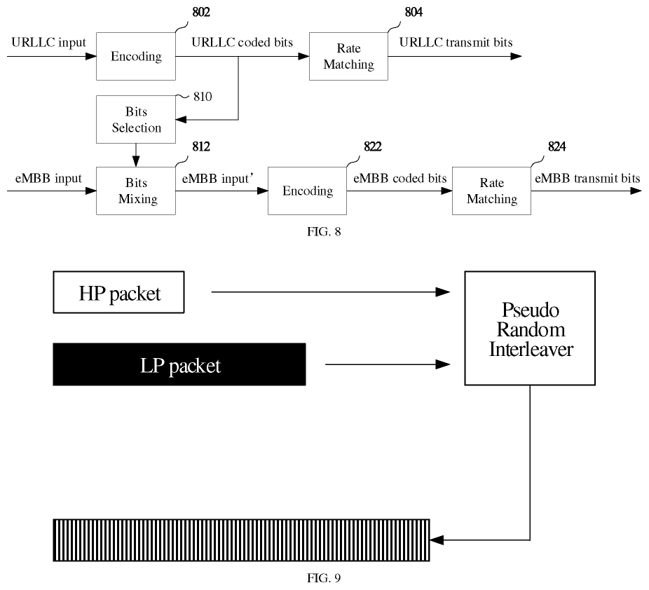

In some embodiments of the present disclosure, an example implementation comprises a bits-selection module, and a bits-mixing module as shown in FIG. 8.

In FIG. 8, a bits selection module is shown at 810, a bits mixing module is shown at 812, and a rate matching module is shown at 824 for coded bits generated by encoding a multiple traffic combined payload by an encoding module 822. Another encoding module 802 and rate matching module 804 for separate coding and transmission of URLLC traffic are also shown.

The present disclosure refers to mixed traffic and multiple traffic. These terms are intended to generally encompass traffic that may be different in one or more traffic parameters. Traffic parameters may also or instead be referred to as traffic properties, characteristics or requirements. Examples herein include latency requirements, QoS requirements, priority, and traffic type (such as URLLC, eMBB).

In some embodiments of the present disclosure, multiple downlink traffic with different QoS requirements to the same UE is multiplexed. For example, the multiple traffic may include a stream of URLLC traffic and a stream of eMBB traffic. In another example, the multiple traffic may include a stream of VR traffic and a stream of AR traffic. In another example, the multiple traffic may include a stream of UCI traffic carrying HARQ ACK/NACK indication and a stream of UCI traffic carrying channel state information (CSI) and scheduling request (SR). In another example, the multiple traffic may include a stream of UCI and a stream of data.

Multiplexing, which may also be referred to as mixing, combining, or embedding, of multiple traffic including a stream of URLLC traffic and a stream of eMBB traffic is consistent with the example shown in FIG. 8.

In some embodiments of the present disclosure, the combined payload size exceeds the maximum size of a CB. Then the combined payload may be segmented into several CBs. For some classes of LDPC codes, some of the information bits, such as the first 2Z information bits, are puncture before transmission, where Z is the lifting size of the code. Therefore, bits at these locations, such as the beginning of the payload, may not be transmitted. In some implementations of the mix-traffic method, embedding higher priority coded bits to such punctured locations of the lower priority payload may not result in a large performance gain and different options have been proposed to avoid such locations, such as embedding to the end of the payload. Therefore, when the combined payload is segmented into several CBs, the embedding bits should avoid the punctured locations of the payload for all CBs. The higher priority traffic is encoded separately first. The coded bits are passed to a rate matching module and the higher priority traffic transmit bits are obtained.

Encoding and rate matching for URLLC traffic (by an encoding module 802 and a rate matching module 804) are also consistent with the example shown in FIG. 8.

The higher priority traffic coded bits are passed to a bits-selection module which will select a desired number of embedding/mixing bits from the coded bits of the higher priority traffic payload. Since the combined payload generated later may be segmented into several CBS, the bits-selection module may select different embedding bits for different CBs. The selected embedding bits are then passed to a bits-mixing module together with the lower priority traffic payload. The two input sequences are mixed together, and the embedding bits may be distributed to all future CBs and avoid the location which may be punctured. The combined sequence is then segmented and each CB is passed to the encoding module. Finally, a rate-matching module will select bits to be transmitted for each CB and all sequences will be concatenated.

These features are consistent with the example shown in FIG. 8 as well, in which URLLC coded bits are passed to a bits-selection module 810, the selected embedding bits are passed to a bits-mixing module 812 together with eMBB payload, the two input sequences to the bits mixing module are mixed together and then passed to the encoding module 822, and a rate-matching module 824 will select bits to be transmitted.

FIG. 8 illustrates an apparatus according to an embodiment. Other embodiments may include additional, fewer, or different components, coupled together in a similar or different way. For example, some embodiments may provide bits selection and bits mixing at 810, 812, for multiple traffic encoding at 822, with or without rate matching at 804 and/or 824. It is also possible that coded bits for bits selection and bits mixing at 810, 812 may be obtained from separate encoding at 802, by a different device or component, such that an apparatus consistent with the present disclosure may obtain coded bits for bits selection and bits mixing without necessarily generating those coded bits. Although (optionally rate matched) coded bits may be transmitted, coded bits may be output without necessarily being transmitted. Coded bits may be output for storage, for example, or output by an encoding module for subsequent transmission by a different component such as a transmitter.

The present disclosure is also not in any way limited to the particular components shown in FIG. 8. Division of functions or features may be different than shown. The various modules are also intended as examples, and may be referred to using different names, such as: “encoder” instead encoding module; bit selection module, bit selector, bits selector, or selector instead of bits selection module; bit mixing module, bit mixer, bits mixer, mixer, multiplexer, or combiner instead of bits selection module; rate matcher instead of rate matching module.

There could be several different implementations of the bits-selection module 810.

One solution can select the same number of embedding bits consecutively after several embedding starting points and each embedding starting point is for one CB of the combined payload. One example of the embedding starting point is the starting point of a redundancy version. These embedding starting points can be the same or the different. The procedure is as follows:
Take the coded bits d₀, d₁, . . . , d_{N-1} from the encoding module 802, the embedding lengths m from the upper layer indication and the number of combined payload CBs C;
Obtain the number of embedding bits for each CB by m/C;
Select C embedding starting points r₀, r₁, . . . , r_{C-1}, and select m/C bits after each of the embedding starting points;
Output the sequence dᵣ_{₀}, . . . , dᵣ_{ₒ}_{+m/C-1}, . . . , dᵣ_{_{C−1}}, . . . , dᵣ_{_{C−1}}_{+m/C-1}.

The higher priority traffic payload size may exceed the maximum size of a CB. Then the higher priority traffic payload is segmented into several CBs.

Another solution can select the same number of embedding bits consecutively after one embedding starting point of each higher priority traffic CB. One example of the embedding starting point is the starting point of a redundancy version of a specific CB. Suppose the higher priority traffic payload is segmented into S CBs, the procedure is as follows:
Take the coded bits d_{i,0}, d_{i,1}, . . . , d_{i,N-1} for each CB from the encoding module 802, where i=0, 1, . . . , S−1, the embedding lengths m from the upper layer indication;
Select S embedding starting points r₀, r₁, . . . , rₛ₋₁ for each CB, and select m/S bits after each CB's the embedding starting points;
Output the sequence d_{0,r}_{₀}, . . . , d_{0,r}_{₀}_{+m/S-1}, . . . , d_{S-1,r}_{_{S−1}}, . . . , d_{S-1,r}_{_{S−1}}_{+m/S-1}.

In the two solutions of above, it should be noted that the coded bits taken from the encoding module 802 may be one or more bits, and the coded bits taken from the encoding module 802 may be part of all of bits output by the encoding module 802. For example, the number of URLLC coded bits output by the encoding module 802 may be 100, the number of the coded bits taken from the URLLC coded bits (i.e., coded bits input to the bits selection module 810) may be an integer which is greater than or equal to 1 and less than or equal to 100.

Moreover, “upper layer indication” in the two solutions of above refers to one possible signaling option for parameters related to multiple traffic coding, such as the starting point and the embedding length. RRC is an example of higher layer signaling that may include such an upper layer indication. Other signaling options for carrying an indication of one or more parameters include DCI or other types of dynamic signaling. Not all embodiments or parameters are necessarily indicated in signaling. For example, one or more parameters may be pre-configured or otherwise available at a device or apparatus in which multiple traffic coding is supported.

There could be several different implementations of the bits-mixing module 812.

One solution is to use an interleaver. The interleaver takes two sequences as input and outputs a combined sequence with a certain permutation. One example of the interleaver can be a pseudo random interleaver. The procedure is as follows:
Take the embedding bits d₀, d₁, . . . , dₘ₋₁ from the bits-selection module 810, the other payload b₀, b₁, . . . , b_{K-1} from the buffer;
The pseudo random interleaver will generate a permutation sequence p₀, p₁, . . . , p_{m+K-1} of 0, 1, . . . , m+K;
Output the sequence c₀, c₁, . . . , c_{m+K-1}, where cᵢ=dₚᵢ, if pᵢ<m, and cᵢ=bₚᵢ₋ₘ otherwise.

The illustration is shown in FIG. 9, and HP denotes higher priority and LP denotes lower priority.

Another solution can insert the higher priority traffic coded bits into the right position of the lower priority traffic payload, so that after segmentation, all higher priority traffic coded bits are at the end of the payload. The procedure is as follows:
Take the embedding bits d₀, d₁, . . . , dₘ₋₁ from the bits-selection module 810, the other payload b₀, b₁, . . . , b_{K-1} from the buffer;
Obtain K_{cb}, the maximum size of a CB for the LDPC code to be used;
Pre-calculate the number of CB, C┌B/(K_{cb}−L)┐, where B=m+K is the total length, and L is the length for some reserved sequence, such as the CRC sequence;
Divide embedding sequence into C block evenly, each of the block can be represented as d_{(i-1)*m/C}, . . . , d_{i*m/C-1}, where i=1, 2, . . . , C;
Insert each embedding block into the position i*K/C of the payload b₀, b₁, . . . , b_{K-1}, where i=1, 2, . . . , C;
Output the sequence b₀, b₁, . . . , b_{K/C-1}, d₀, . . . , d_{m/C-1}, . . . b_{(C-1)*K/C}, . . . , b_{K-1}, d_{(C-1)*m/C}, . . . , dₘ₋₁.

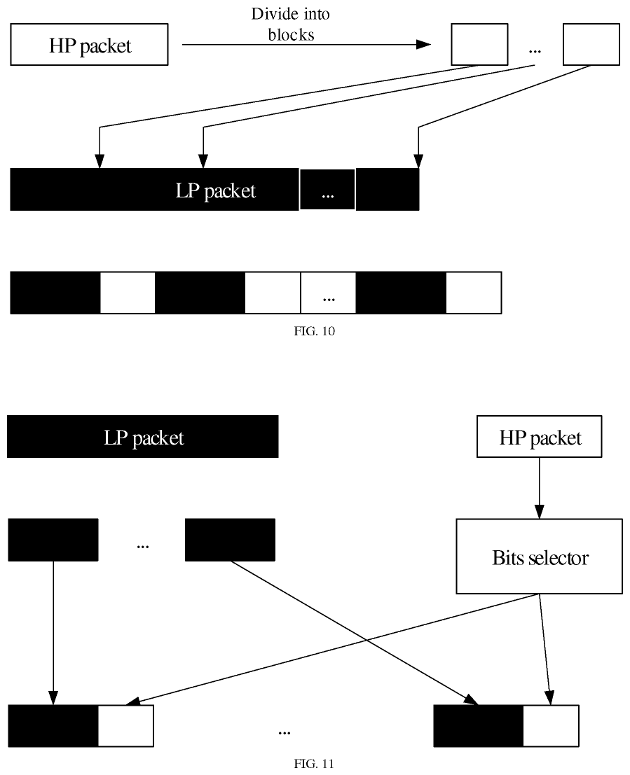

The illustration is shown in FIG. 10, and HP denotes higher priority and LP denotes lower priority.

Another solution can perform segmentation on the lower priority traffic first and append right amount of the higher priority traffic coded bits at the end of each CB. The procedure is as follows:
Take the embedding bits d₀, d₁, . . . , dₘ₋₁ from the bits-selection module 810, the other payload b₀, b₁, . . . , b_{K-1} from the buffer;
Obtain K_{cb}, the maximum size of a CB for the LDPC code to be used;
One TB is segmented into C=B/(K_{cb}−L−P) CBs, where B is the length of the eMBB payload, L is the length for some reserved sequence, such as the CRC sequence, and P is the length of embedding bits per CB;
The eMBB payload will be divided into C blocks, each of the block can be represented as b_{(i-1)*K/C}, . . . , d_{i*K/C-1}, where i=1, 2, . . . , C;
For each CB, select and combine P bits from the higher priority coded bits;
Output the sequence b₀, b₁, . . . , b_{K/C-1}, d₀, . . . , d_{P-1}, . . . b_{(C-1)*K/C}, . . . , b_{K-1}, d_{(C-1)*P}, . . . , d_{C+P-1}.

The illustration is shown in FIG. 11, and HP denotes higher priority and LP denotes lower priority.

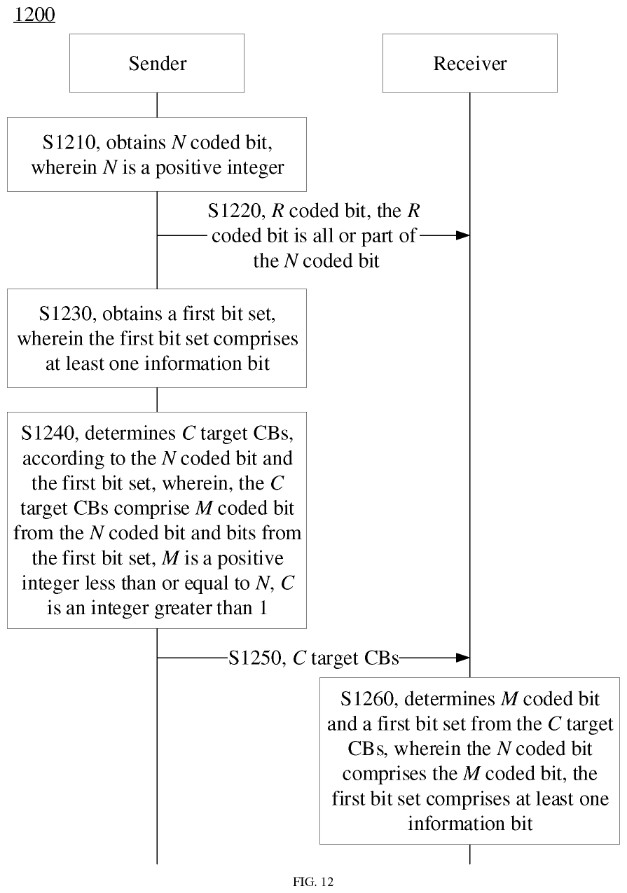

Various aspects of the present disclosure are described herein and shown in the drawings by way of example. FIG. 12 is a schematic diagram illustrating a more general method of communication according to embodiments.

In the method 1200, the sender may be any device or chip that supports wireless communication, such as a BS or an UE illustrated in FIG. 1, or chips applied on the BS or the UE. The receiver may also be any device or chip that supports wireless communication, such as a BS or an UE illustrated in FIG. 1, or chips applied on the BS or the UE. The forms of the sender and the receiver are not restricted in any embodiment of this application.

The sender and the receiver may be connected through a wireless network, for example, the sender and the receiver may be connected through a terrestrial network or a non-terrestrial network. It is understood that the sender and the receiver may alternatively be connected through other wireless network. There is no restriction herein.

With reference to FIG. 12, the method 1200 comprises:
S1210, the sender obtains N coded bit, wherein N is a positive integer.

The N coded bit may be one or more bits encoded by a coding method, such as an LDPC code. For example, the N coded bit may be a HARQ ACK/NACK indication encoded by LDPC. For another example, the N coded bit may be a whole mother codeword. There is no restriction for the number and the coding method of the N coded bit.

When N is an integer greater than 1, the N coded bit may correspond to one or more traffic.

For example, the N coded bit may be the bits of a stream of URLLC traffic. For another example, the N coded bit may be the bits of a stream of VR traffic and a stream of UCI traffic. There is no restriction for the content of the N coded bit.

The sender may generate the N coded bit by itself, or it may receive the N coded bit from other apparatus. In the later case, the sender plays the role of a relay node.

After obtaining the N coded bit determining the C target CBs, the sender may perform the S1220 below.

S1220, the sender sends R coded bit, wherein the R coded bit is all or part of the N coded bit.

Correspondingly, for the receiver, it receives the R coded bit.

The R coded bit may be transmitted after processing of physical layer at the sender and be decoded at the receiver. The sender may send the R coded bit periodically or aperiodically. Also, the sender may send the R coded bit autonomously, or based on a request of the receiver. In any embodiment of this application, there is no restriction for how to send or receive the R coded bit.

Besides the S1210 and S1220, the sender may perform the S1230 below. It should be noted that in the method 1200, S1230 may be performed after S1220, or be performed before S1210, or be performed with S1210 or S1220.

S1230, the sender obtains a first bit set, wherein the first bit set comprises at least one information bit.

The first bit set may be one or more bit sequences, one or more bit groups, one or more bit blocks, or any other form. For example, the first bit set may be one or more CBs, or one or more TBs. There is no restriction for the form of the first bit set. When the first bit set is one or more TBs, the one or more TBs may be segmented into several CBs to perform the following procedure.

The first bit set may correspond to one or more traffic. For example, the first bit set may be the bits of a stream of eMBB traffic, or the first bit set may be the bits of a stream of AR traffic and a stream of other data.

In an optional implementation, the priority of the N coded bit is higher than the priority of the first bit set.

For example, the N coded bit is the bits of a stream of UCI traffic carrying HARQ ACK/NACK indication, while the first bit set is the bits of a stream of VR traffic, wherein the priority of the UCI traffic is higher than the priority of the VR traffic.

The sender may generate the first bit set by itself, or it may receive the first bit set from other apparatus. In the later case, the sender plays the role of a relay node.

S1240, the sender determines C target CBs, according to the N coded bit and the first bit set, wherein, the C target CBs comprise M coded bit from the N coded bit and bits from the first bit set, M is a positive integer less than or equal to N, C is an integer greater than 1.

After obtaining the N coded bit and the first bit set, the sender may encode them by LDPC or any other coding method. So except for the M coded bit from the N coded bit and bits from the first bit set, the C target CBs may also comprise other bits, such as CRC bits.

The N coded bit may be transmitted in whole or in part, and the first bit set may also be transmitted in whole or in part. There is no restriction for how to transmit the N coded bit and the first bit set.

For example, the N coded bit comprises one bit, the first bit set comprises 100 bits, then the M equals to 1, and the number of bits from the first bit set may be an integer greater than or equal to 1, and less than or equal to 100.

For another example, the N coded bit comprises 10 bits, the first bit set comprises 100 bits, then the M may be an integer greater than or equal to 1, and less than or equal to 10, and the number of bits from the first bit set may be an integer greater than or equal to 1, and less than or equal to 100.

After obtaining the C target CBs, the sender may perform the next procedure.

S1250, the sender sends the C target CBs.

Correspondingly, for the receiver, it receives the C target CBs.

The C target CBs may be transmitted after processing of physical layer at the sender and be decoded at the receiver, there is no restriction for how to send or receive the C target CBs.

The sender may send the C target CBs periodically or aperiodically. Also, the sender may send the C target CBs autonomously, or based on a request of the receiver. In any embodiment of this application, there is no restriction for how to send or receive the C target CBs.

Moreover, it is understood that the size of any one of the C target CBs is less than or equal to the maximum size of a CB.

After receiving the C target CBs, the receiver may perform the S1260.

S1260, the receiver determines M coded bit and a first bit set from the C target CBS, wherein the N coded bit comprises the M coded bit, the first bit set comprises at least one information bit.

For example, the M coded bit corresponds to URLLC payload and the first bit set corresponds to eMBB payload, the decoding procedure is described as follows and any successful decoding can terminate the procedure early:
[First decoding attempt] The receiver decodes the URLLC payload after receiving URLLC transmit bits, i.e., the N coded bit. In this case, even if this decoding is not successful, its decoder LLR for the embedded coded bits is still passed for the decoding of the eMBB packet.
[Second decoding attempt] After the reception of eMBB payload or at least the URLLC related portion in the C target CBs, the receiver will combine the channel LLR belonging to URLLC coded bits and decode the URLLC payload again. The receiver can optionally skip this decoding attempt and directly go to the next step.
[Third decoding attempt] After finishing the eMBB decoding, the receiver will combine the decoder extrinsic LLR belonging to the URLLC coded bits and decode the URLLC again. The receiver can optionally skip this decoding attempt and only keep the first two attempts.

To summarize, to improve the performance of transmission, all or part of the N coded bit will be transmitted independently, such as R coded bit, and all or part of the N coded bit, such as M coded bit, need to be embedded into the first bit set for retransmission. In some cases, the size of bits after embedding (or combining) may exceed the maximum size of a CB, which may cause part of bits after embedding (or combining) being dropped or punctured. In the present implementation, bits after embedding are divided into several sets, i.e., the C target CBs, thus, the probability that the size of a target CB exceeds the maximum size of a CB can be reduced, so that the effect of embedding (or combining) operation on the transmission of the first bit set can be reduced without affecting the retransmission of the M coded bit.

In the process of determining the C target CBs, the sender may insert (or embed) the N coded bit into the first bit set, or combine the N coded bit with the first bit set. Moreover, the sender may obtain M coded bit from the N coded bit, and then insert (or embed) the M coded bit into the first bit set, or combine the M coded bit with the first bit set.

As some optional implementations, several embodiments of obtaining the M coded bit from the N coded bit will be introduced below.

In an optional implementation, the sender may perform:
determining the M coded bit from the N coded bit, wherein M is an integer greater than 1.

In the present implementation, M is an integer greater than 1, which means more than one coded bit is embedded into the first bit set, thus, more of the N coded bit are retransmitted to enhance the reliability of transmission of the N coded bit.

The M coded bit may be any coded bits of the N coded bit, as an optional implementation, the N coded bit is a first bit sequence which comprises several coded bits corresponding to an URLLC CB, the M coded bit comprises C bit sequences, the start point of any one of the C bit sequences is a start point of a RV of the first bit sequence. The C bit sequences correspond to C RVs, each of the CRVs can be jointly decoded with other RVs corresponding to the same mother codeword at a receiver, to obtain a better decoding gain.

In an optional implementation, the M coded bit may comprise C bit sets, wherein any one of the C bit sets comprises M/C bit.

The C bit sets may be C bit sequences, C bit blocks, or C bit groups, there is no restriction for the form of the C bit sets. By dividing the M coded bit equally, each target CB comprises less embedded bits, so that the effect of embedding operation on the transmission of the first bit set can be reduced.

For example, the sender may select the same number of embedding bits consecutively after several embedding starting points and each embedding starting point is for one higher priority CB. One example of the embedding starting point is the starting point of a redundancy version. These embedding starting points can be the same or the different. The procedure is as follows:
Take the coded bits d₀, d₁, . . . , d_{N-1} from the encoding module 802, the embedding lengths M from the upper layer indication and the number of combined payload CBs C;
Obtain the number of embedding bits for each CB by M/C;
Select C embedding starting points r₀, r₁, . . . , r_{C-1}, and select M/C bits after each of the embedding starting points;
Output the sequence dᵣ_{₀}, . . . , dᵣ_{₀}_{+M/C-1}, . . . , dᵣ_{_{C−1}}, . . . , dᵣ_{_{C−1}}_{+M/C-1}.

Wherein, the coded bits d₀, d₁, . . . , d_{N-1} means the N coded bit, the M/C bits means one of the C bit sets, the sequence dᵣ_{₀}, . . . , dᵣ_{₀}_{+M/C-1}, . . . , dᵣ_{_{C−1}}, . . . , dᵣ_{_{C−1}}_{+M/C-1} means the M coded bit.

In an optional implementation, the size of TB corresponding to the N coded bit may exceed the maximum size of a CB. Then the TB corresponding to the N coded bit will be segmented into several CBs.

In the above case, the N coded bit comprises S coded bit sets, wherein Sis an integer greater than 1, before inserting the M coded bit into the first bit set or combining the M coded bit with the first bit set, the sender may perform:
determining S bit subsets from the S coded bit sets, the S bit subsets comprise the M coded bit, wherein M is an integer greater than 1.

The S coded bit sets may be S bit sequences, S bit blocks, or S bit groups, there is no restriction for the form of the S coded bit sets. For example, the S coded bit sets are S CBs, and the concatenation of the S CBs is the N coded bit.

In an optional implementation, any one of the S bit subsets comprises M/S bit.

For example, there are 2 mother codewords (i.e., S coded bit sets), each of the 2 mother codewords includes 10 bits, then 5 bits could be extracted from each of the 2 mother codewords, to form the S bit subsets.

By extracting the same number of bits from each of the S coded bit sets, any one of the S bit subsets comprises the same number of bits, so that the transmission reliability of each bit subset will not differ too much.

In an optional implementation, the S coded bit sets are S second bit sequences, the S bit subsets are S bit subsequences, the start point of any one of the S bit subsequences is a start point of a redundancy version of a second bit sequence.

In the present implementation, the S bit subsequences correspond to S RVs, which means that, any two of the S RVs may come from different mother codewords, or some of the S RVs may come from the same mother codeword. Each of the S RVs can be jointly decoded with other RVs corresponding to the same mother codeword (or the same second bit sequence) at a receiver to obtain a better decoding gain.

In an optional implementation, the S bit subsets correspond to the S coded bit sets one to one.

As an example, the S bit subsets correspond to the S coded bit sets one to one means extracting one or more bits from each of the S coded bit sets, thus, each of the S coded bit sets has a chance to be retransmitted, so that the transmission reliability of some coded bit sets will not be too low.

For example, the sender may select the same number of embedding bits consecutively after one embedding starting point of each higher priority CB. One example of the embedding starting point is the starting point of a redundancy version of a higher priority CB. Suppose the higher priority traffic payload is segmented into S CBs, the procedure is as follows:
Take the coded bits d_{i,0}, d_{i,1}, . . . , d_{i,N-1} for each CB from the encoding module 802, where i=0, 1, . . . , S−1, the embedding lengths M from the upper layer indication;
Select S embedding starting points r₀, r₁, . . . , rₛ₋₁ for each higher priority CB, and select M/S bits after each CB's the embedding starting points;
Output the sequence d_{0,r}_{₀}, . . . , d_{0,r}_{ₒ}_{+M/S-1}, . . . , d_{S-1,r}_{_{S−1}}, . . . , d_{S-1,r}_{_{S−1}}_{+M/S-1}.
Wherein, the coded bits d_{i,0}, d_{i,1}, . . . , d_{i,N-1} means the N coded bit, the M/S bits means one of the S bit subsets, the sequence d_{0,r}_{₀}, . . . , d_{0,r}_{ₒ}_{+m/S-1}, . . . , d_{S-1,r}_{_{S−1}}, . . . , d_{S-1,r}_{_{S−1}}_{+m/S-1} means the M coded bit.

After obtaining the M coded bit, the sender may insert the M coded bit into the first bit set or combine the M coded bit with the first bit set, to determine the C target CBs.

As some optional implementations, several embodiments of determining the C target CBs will be introduced below.

In an optional implementation, the sender may perform:
determining a third bit sequence, according to the N coded bit and the first bit set, the third bit sequence comprises the M coded bit and bits from the first bit set;
determining the C target CBs, by dividing the third bit sequence.

The third bit sequence is obtained by inserting or embedding M coded bits into the first bit set or combining M coded bits with the first bit set, after that, the third bit sequence is divided into C target CBs, thus, the probability that the size of a target CB exceeds the maximum size of a CB can be reduced, so that the effect of embedding operation or combining operation on the transmission of the first bit set can be reduced without affecting the retransmission of the M coded bit.

In an optional implementation, the determining a third bit sequence, comprises: determining the third bit sequence, by an interleaver.

The interleaver may take two sequences as input and output a combined sequence with a certain permutation. One example of the interleaver may be a pseudo random interleaver, there is no restriction for the interleaver. By using an interleaver, the way to determine the third bit sequence is simplified. An optional procedure is as follows:
Take the embedding bits d₀, d₁, . . . , d_{M-1} from the bits-selection module 810, the other payload b₀, b₁, . . . , b_{K-1} from the buffer;
The pseudo random interleaver will generate a permutation sequence p₀, p₁, . . . , p_{M+K-1} of 0, 1, . . . , M+K;
Output the sequence c₀, c₁, . . . , c_{M+K-1}, where cᵢ=dₚᵢ, if pᵢ<m, and cᵢ=b_{pi-M} otherwise.

Wherein, the embedding bits d₀, d₁, . . . , d_{M-1} means the M coded bit, the other payload b₀, b₁, . . . , b_{K-1} means the first bit set, the sequence c₀, c₁, . . . , c_{M+K-1} means the third bit sequence.

After obtaining the third bit sequence, the C target CBs may be generated by dividing the third bit sequence into C blocks.

In an optional implementation, the sender may perform:
determining C bit sets, according to the M coded bit, wherein the C bit sets comprise the M coded bit, wherein M is an integer greater than 1;
determining the third bit sequence, by inserting the C bit sets into the first bit set.

In the present implementation, C could be calculated according to the sum of the number of the M coded bit and the number of bits in the first bit set, so the M coded bit could be divided into C bit sets in advance, and then be inserted into the first bit set.

In an optional implementation, C is proportional to B, and C is inversely proportional to K_{cb}−L, wherein B is the sum of the number of the M coded bit and the number of bits in the first bit set, K_{cb} is the maximum size of a CB, L is the number of bits except for information bits and embedded bits in a CB.

The C is proportional to B means that C increases as B increases, or C decreases as B decreases. Analogously, the C is inversely proportional to K_{cb}−L means that C decreases as K_{cb}−L increases, or C increases as K_{cb}−L decreases. For example, C=B/(K_{cb}−L) or C=┌B/(K_{cb}−L)┐.

The bit except for information bits and embedded bits in a CB may be CRC bits, or CRC bits and other embedded bits.

An optional procedure of determining C bit sets and inserting the C bit sets into the first bit set is as follows:
Take the embedding bits d₀, d₁, . . . , d_{M-1} from the bits-selection module 810, the other payload b₀, b₁, . . . , b_{K-1} from the buffer;
Obtain K_{cb}, the maximum size of a CB for the LDPC code to be used;
Pre-calculate the number of CB, C=┌B/(K_{cb}−L)┐, where B=M+K is the total length, and L is the length for some reserved sequence, such as the CRC sequence;
Divide embedding sequence into C blocks evenly, each of the block can be represented as d_{(i-1)*M/C}, . . . , d_{i*M/C-1}, where i=1, 2, . . . , C;
Insert each embedding block into the position i*K/C of the payload b₀, b₁, . . . , b_{K-1}, where i=1, 2, . . . , C;
Output the sequence b₀, b₁, . . . , b_{K/C-1}, d₀, . . . , d_{M/C-1}, . . . b_{(C-1)+K/C}, . . . , b_{K-1}, d_{(C-1)*M/C}, . . . , d_{M-1}.

Wherein, the embedding bits d₀, d₁, . . . , d_{M-1} means the M coded bit, the other payload b₀, b₁, . . . , b_{K-1} means the first bit set, the C blocks means the C bit sets, the sequence b₀, b₁, . . . , b_{K/C-1}, d₀, . . . , d_{M/C-1}, . . . b_{(C-1)+K/C}, . . . , b_{K-1}, d_{(C-1)*M/C}, . . . , d_{M-1} means the third bit sequence.

After obtaining the third bit sequence, the C target CBs may be generated by dividing the third bit sequence into C blocks.

In an optional implementation, the sender may perform:
dividing the first bit set into C CBs;
determining C bit sets, according to the M coded bit, wherein the C bit sets comprise the M coded bit, wherein M is an integer greater than 1;
determining the C target CBs, by combining the C bit sets and the C CBs.

In the present implementation, C could be calculated according to the sum of the number of the M coded bit and the number of bits in the first bit set, so the first bit set could be divided into C CBs in advance, and the M coded bit could also be divided into C bit sets in advance, then the C CBs could be combined with the C bit sets to generate the C target CBs.

For the combining the C bit sets and the C CBs, one bit set may combine with one CB, or multiple bit sets may combine with one CB, or one bit set may combine with multiple CBs.

In an optional implementation, any one of the C bit sets combines with any one of the C CBs.

For example, there are 3 bit sets like bit set A, bit set B, and bit set C, and 3 CBs like CB1, CB2, and CB3, then bit set A could be combined with CB1, bit set B could be combined with CB2, and bit set C could be combined with CB3. Alternatively, bit set A could be combined with CB2, bit set B could be combined with CB1, and bit set C could be combined with CB3. There is no restriction for which of the C bit sets be combined with which of the C CBs.

By combining each bit set of the C bit sets with each CB of the C CBs, any one of the C target CBs will not comprise too many coded bits, so that the transmission reliability of each CB of the C CBs will not differ too much.

In an optional implementation, C is proportional to B, and C is inversely proportional to K_{cb}−L−P, wherein B is the number of bits in the first bit set, Kob is the maximum size of a CB, L is the number of bit except for information bits and embedded bits in a CB, P is the number of bits which are embedded in a CB.

The C is proportional to B means that C increases as B increases, or C decreases as B decreases. Analogously, the C is inversely proportional to K_{cb}−L means that C decreases as K_{cb}−L increases, or C increases as K_{cb}−L decreases. For example, C=B/(K_{cb}−L−P) or C=┌B/(K_{cb}−L−P)┐.

The bit except for information bits and embedded bits in a CB may be CRC bits, or CRC bits and other embedded bits.

An optional procedure of determining C bit sets and inserting the C bit sets into the first bit set is as follows:
Take the embedding bits d₀, d₁, . . . , d_{M-1} from the bits-selection module 810, the other payload b₀, b₁, . . . , b_{K-1} from the buffer;
Obtain K_{cb}, the maximum size of a CB for the LDPC code to be used;
One TB is segmented into C=B/(K_{cb}−L−P) CBs, where B is the length of the eMBB payload, L is the length for some reserved sequence, such as the CRC sequence, and P is the length of embedding bits per CB;
The eMBB payload will be divided into C blocks, each of the block can be represented as b_{(i-1)*K/C}, . . . , d_{i*K/C-1}, where i=1, 2, . . . , C;
For each CB, select and combine P bits from the higher priority coded bits;
Output the sequence b₀, b₁, . . . , b_{K/C-1}, d₀, . . . , d_{P-1}, . . . b_{(C-1)*K/C}, . . . , b_{K-1}, d_{(C-1)+P}, . . . , d_{C*P-1}.

Wherein, the embedding bits d₀, d₁, . . . , d_{M-1} means the M coded bit, the other payload b₀, b₁, . . . , b_{K-1} means the first bit set, the C blocks means the C CBs from the first bit set, the P bits means one of the C bit sets from the M coded bit, the sequence b₀, b₁, . . . , b_{K/C-1}, d₀, . . . , d_{P-1}, . . . . b_{(C-1)*K/C}, . . . , b_{K-1}, d_{(C-1)*P}, . . . , d_{C*P-1} means the combination of the C bit sets and the C CBs.

As an optional implementation, in the above implementations except the implementation with a pseudo random interleaver, the first 2Z bits of any one of the C target CBs are 2Z information bits from the first bit set, wherein Z is the lifting size of a code which is used for encoding the C target CBs.

The first 2Z bits of a CB may be punctured, by placing the N coded bit beyond the first 2Z bits, the transmission reliability of the N coded bit could be enhanced.

The examples of methods provided in the embodiments of this application are described in detail in the above, and it is understood that the corresponding devices, in order to achieve the above functions, contain the corresponding hardware structures and/or software modules to implement each function. It should be readily apparent to those skilled in the art that, in combination with the units and algorithmic steps of the examples described in the embodiments disclosed herein, this application may be implemented in hardware or in a combination of hardware and computer software. Whether a function is performed in hardware or computer software drives hardware depends on the specific application and design constraints of the technical solution. Technical professionals may use different methods for each particular application to achieve the described functionality, but such implementation should not be considered beyond the scope of this application.

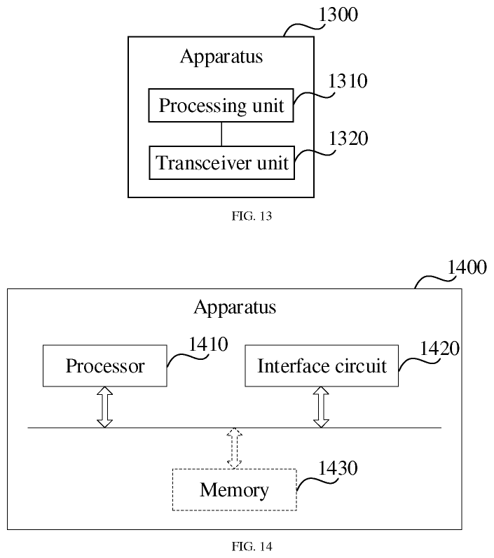

FIG. 13 and FIG. 14 are two schematic diagrams of structure of communication apparatus provided by the embodiments of this application, which may be used to implement the functions of the terminal or BS in the embodiments of the above method, and therefore also have the advantageous effects of the embodiments of the above method. In embodiments of this application, these apparatus may be terminals or BSs as shown in FIG. 1, or modules (e.g., chips) applied to terminals or BSs.

As shown in FIG. 13, apparatus 1300 comprises a processing unit 1310 and a transceiver unit 1320. The transceiver unit 1320 performs the receiving step and/or the sending step under the control of the processing unit 1310, where the transceiver unit 1320 is a sending unit when a sending step is performed, and the transceiver unit 1320 is a receiving unit when a receiving step is performed. The apparatus 1300 is used to implement the functions of the terminal or BS in the method embodiment described in the above.

While the apparatus 1300 is used to implement the function of the sender in the embodiment of the method described in FIG. 12, the processing unit 1310 is configured to perform: obtaining N coded bit, wherein N is a positive integer; obtaining a first bit set, wherein the first bit set comprises at least one information bit; determining C target code blocks (CBs), according to the N coded bit and the first bit set, wherein, the C target CBs comprise M coded bit from the N coded bit and bits from the first bit set, M is a positive integer less than or equal to N, C is an integer greater than 1.

Optionally, the processing unit 1310 is further configured to perform: determining the M coded bit from the N coded bit, wherein M is an integer greater than 1.

Optionally, the M coded bit comprises C bit sets, any one of the C bit sets comprises M/C bit.

Optionally, the N coded bit is a first bit sequence, the M coded bit comprises C bit sequences, the start point of any one of the C bit sequences is a start point of a redundancy version of the first bit sequence.

Optionally, the N coded bit comprises S coded bit sets, Sis an integer greater than 1, the processing unit 1310 is further configured to perform: determining S bit subsets from the S coded bit sets, the S bit subsets comprise the M coded bit, wherein M is an integer greater than 1.

Optionally, any one of the S bit subsets comprises M/S bit.

Optionally, the S coded bit sets are S second bit sequences, the S bit subsets are S bit subsequences, the start point of any one of the S bit subsequences is a start point of a redundancy version of a second bit sequence.

Optionally, the S bit subsets correspond to the S coded bit sets one to one.

Optionally, the S coded bit sets are S CBs, and the concatenation of the S CBs is the N coded bit.

Optionally, the processing unit 1310 is further configured to perform: determining a third bit sequence, according to the N coded bit and the first bit set, the third bit sequence comprises the M coded bit and bits from the first bit set; determining the C target CBs, by dividing the third bit sequence.

Optionally, the processing unit 1310 is further configured to perform: determining the third bit sequence, by an interleaver.

Optionally, the processing unit 1310 is further configured to perform: determining C bit sets, according to the M coded bit, wherein the C bit sets comprise the M coded bit, wherein M is an integer greater than 1; determining the third bit sequence, by inserting the C bit sets into the first bit set.

Optionally, C is proportional to B, and C is inversely proportional to K_{cb}−L, wherein B is the sum of the number of the M coded bit and the number of bits in the first bit set, K_{cb} is the maximum size of a CB, L is the number of bits except for information bits and embedded bits in a CB.

Optionally, the C is proportional to B, and C is inversely proportional to K_{cb}−L, comprises: C=B/(K_{cb}−L).

Optionally, the processing unit 1310 is further configured to perform: dividing the first bit set into C CBs; determining C bit sets, according to the M coded bit, wherein the C bit sets comprise the M coded bit, wherein M is an integer greater than 1; determining the C target CBs, by combining the C bit sets and the C CBs.

Optionally, any one of the C bit sets combines with any one of the C CBs.

Optionally, C is proportional to B, and C is inversely proportional to K_{cb}−L−P, wherein B is the number of bits in the first bit set, K_{cb} is the maximum size of a CB, L is the number of bit except for information bits and embedded bits in a CB, P is the number of bits which are embedded in a CB.

Optionally, the C is proportional to B, and C is inversely proportional to K_{cb}−L−P, comprises: C=B/(K_{cb}−L−P).

Optionally, the bit except for information bits and embedded bits in a CB is a CRC.

Optionally, the first 2Z bits of any one of the C target CBs are 2Z information bits from the first bit set, wherein Z is the lifting size of a code which is used for encoding the C target CBs.

Optionally, the size of any one of the C target CBs is less than or equal to the maximum size of a CB.

Optionally, the N coded bit corresponds to at least two traffic, wherein N is an integer greater than 1.

Optionally, the priority of the N coded bit is higher than the priority of the first bit set.

Optionally, the transceiver unit 1320 is configured to perform: sending the C target CBs.

Optionally, the transceiver unit 1320 is configured to perform: sending R coded bit, wherein the R coded bit is all or part of the N coded bit, R is a positive integer less than or equal to N.

While the apparatus 1300 is used to implement the function of the receiver in the embodiment of the method described in FIG. 12, the transceiver unit 1320 is configured to perform: obtaining R coded bit, R is a positive integer; determining N coded bit according to the R coded bit, N is a positive integer greater than or equal to R; obtaining C target code blocks (CBs), C is an integer greater than 1; the processing unit 1310 is configured to perform: determining M coded bit and a first bit set from the C target CBs, wherein the N coded bit comprises the M coded bit, the first bit set comprises at least one information bit.

Optionally, the M coded bit comprises C bit sets, any one of the C bit sets comprises M/C bit.

Optionally, the N coded bit is a first bit sequence, the M coded bit comprises C bit sequences, the start point of any one of the C bit sequences is a start point of a redundancy version of the first bit sequence.

Optionally, the N coded bit comprises S coded bit sets, the S coded bit sets comprise S bit subsets, the S bit subsets comprise the M coded bit, wherein Sis an integer greater than 1, M is an integer greater than 1.

Optionally, any one of the S bit subsets comprises M/S bit.

Optionally, the S coded bit sets are S second bit sequences, the S bit subsets are S bit subsequences, the start point of any one of the S bit subsequences is a start point of a redundancy version of a second bit sequence.

Optionally, the S bit subsets correspond to the S coded bit sets one to one.

Optionally, the S coded bit sets are S CBs, and the concatenation of the S CBs is the N coded bit.

Optionally, the M coded bit comprises C bit sets, the C bit sets are embedded in the first bit set.

Optionally, C is proportional to B, and C is inversely proportional to K_{cb}−L, wherein B is the sum of the number of the M coded bit and the number of bits in the first bit set, K_{cb} is the maximum size of a CB, L is the number of bits except for information bits in a CB.

Optionally, the C is proportional to B, and C is inversely proportional to K_{cb}−L, comprises: C=B/(K_{cb}−L).

Optionally, the first bit set comprises C CBs, the M coded bit comprises C bit sets, the C CBs are combined with the C bit sets.

Optionally, any one of the C bit sets combines with any one of the C CBs.

Optionally, C is inversely proportional to B, and C is inversely proportional to K_{cb}−L−P, wherein B is the number of bits in the first bit set, Kob is the maximum size of a CB, L is the number of bit except for information bits and embedded bits in a CB, P is the number of bits which are embedded in a CB.

Optionally, the C is proportional to B, and C is inversely proportional to K_{cb}−L−P, comprises: C=B/(K_{cb}−L−P).

Optionally, the bit except for information bits and embedded bits in a CB is a CRC.

Optionally, the first 2Z bits of any one of the C target CBs are 2Z information bits from the first bit set, wherein Z is the lifting size of a code which is used for encoding the C target CBs.

Optionally, the size of any one of the C target CBs is less than or equal to the maximum size of a CB.

Optionally, the N coded bit corresponds to at least two traffic, wherein N is an integer greater than 1.

Optionally, the priority of the N coded bit is higher than the priority of the first bit set.

The apparatus 1300 may be a terminal or a BS. The processing unit 1310 may be implemented by hardware or by software. When the processing unit 1310 is implemented by hardware, the processing unit 1310 is a logic circuit, an integrated circuit, etc. When the processing unit 1310 is implemented by software, the processing unit 1310 may be a general-purpose processor, implemented by reading software code stored in a memory unit, which may be integrated in the processing unit 1310 or may be located outside the processing unit 1310 and exist independently.

As shown in FIG. 14, apparatus 1400 includes a processor 1410 and an interface circuit 1420. The processor 1410 and the interface circuit 1420 are coupled to each other. It is understood that the interface circuit 1420 may be either a transceiver or an input-output interface. Optionally, the apparatus 1400 may also include a memory 1430 to store the instructions executed by the processor 1410, or to store the input data required by the processor 1410 to run the instructions, or to store the data produced after the processor 1410 has run the instructions.

When the apparatus 1400 is used to implement the method shown in FIG. 12 or any other method described in the above, the processor 1410 is used to implement the functions of the above processing unit 1310 and the interface circuit 1420 is used to implement the functions of the above transceiver unit 1320.

When the apparatus 1400 is a terminal chip (that is, a chip applied to a terminal), the terminal chip implements the functions of the terminal in an embodiment of the above method. The terminal chip receives information from the BS, which can be understood as the information is first received by other modules in the terminal (such as radio frequency module or antenna), and then sent to the terminal chip by these modules. The terminal chip sends information to the BS, which can be understood as the information is first sent to other modules in the terminal (such as radio frequency module or antenna), and then sent to the BS by these modules.

When the apparatus 1400 is a BS chip (i.e., a chip applied to a BS), the BS chip implements the functions of the BS in an embodiment of the above method. The BS chip receives information from the terminal, which can be understood as the information is first received by other modules in the BS (such as the radio frequency module or antenna), and then sent to the BS chip by these modules. The BS chip sends information to the terminal, which can be understood as the information is sent to other modules in the BS (such as radio frequency module or antenna), and then sent to the terminal by these modules.

In this application, entity A sends information to entity B, could be from A to B directly or from A to B through other entities. Similarly, entity B receives information from entity A, could be from B to A directly or from B to A through other entities. Here entities A and B may be RAN nodes or terminals, or modules inside the RAN nodes or terminals. The sending and receiving of information may be the information interaction between RAN nodes and terminals, for example, the information interaction between BSs and terminals. The sending and receiving of information can also be the information interaction between two RAN nodes, such as the information interaction between CU and DU. The sending and receiving of information can also be the information interaction between different modules in a device, for example, the information interaction between a terminal chip and other modules in the terminal, or the information interaction between a BS chip and other modules in the BS.

It is understood that the processor in the embodiments of the present application may be a central processor unit (CPU), other general-purpose processors, digital signal processors (DSP), ASIC, FPGA, or any other programmable logic device, transistor logic device, hardware component or any combination thereof. A general-purpose processor may be a microprocessor or any conventional processor.

The method steps in embodiments of the present application may be implemented in hardware or in software instructions that can be executed by a processor.

The above embodiments may be implemented in whole or in part by instructions, software, hardware, firmware, or any combination thereof.

When implemented by instructions, the instructions may be composed of corresponding software modules, the software modules may be stored in a computer readable storage medium. The computer readable storage medium may be a volatile or non-volatile storage medium, or may include both types of volatile and non-volatile storage media. The non-volatile storage medium may be a flash memory, hard disk, mobile hard disk, read-only memory (ROM), programmable ROM (PROM), erasable PROM (EPROM), electrically EPROM (EEPROM), compact disc ROM (CD-ROM), or any other form of non-volatile storage medium well known in the art. The volatile storage medium may be a random access memory (RAM), by illustrative but not restrictive, many forms of RAM are available, such as, registers, static RAM (SRAM), dynamic RAM (DRAM), synchronous DRAM (SDRAM), double data rate SDRAM (DDR SDRAM), enhanced SDRAM (ESDRAM), or any other form of volatile storage medium well known in the art.

An exemplary storage medium is coupled to a processor so that the processor can read information from the storage medium and can write information to the storage medium. The storage medium can also be an integral part of the processor. The processor and the storage medium can be located in an ASIC. Alternatively, the ASIC can be located in a BS or terminal. Processors and storage media can also exist as discrete components in the BS or terminal.

When implemented by software, it can be implemented in whole or in part in the form of a computer program product. The computer program product includes one or more computer programs or instructions. When the computer programs or instructions are loaded and executed on a computer, the process or function described in the embodiment of this application is executed in whole or in part. The computer may be a general computer, a specific computer, a computer network, a network device, an UE or other programmable device. The computer programs or instructions may be stored in or transmitted from one computer readable storage medium to another, for example, the computer programs or instructions may be transmitted from one web site, computer, server or data center to another web site, computer, server or data center by wired or wireless means. The computer readable storage medium may be any available media that the computer can access or a data storage device such as a server or a data center that integrates one or more available media. The available medium may be a magnetic medium, for example, a floppy disk, hard disk, magnetic tape; it can also be an optical medium, for example, a digital video disc; it can also be a semiconductor medium, for example, a solid state disk.

Finally, regarding the embodiments of this application, there are a few more declarations:

First, in the embodiments of this application, the first, second and various numerical numbers are only for the purpose of describing convenient distinctions and are not used to limit the scope of the embodiments of this application. For example, the first information and the third information represent two information, which may be two different information or the same information.

Second, in the embodiments of this application, “indicate” may include direct indicate and indirect indicate, as well as explicit indicate and implicit indicate. The information indicated by a certain information is called the information to be indicated. In the concrete implementation process, there are many ways to indicate the information to be indicated. For example, the information to be indicated can be directly indicated, such as the information to be indicated itself or the index of the information to be indicated. It can also indirectly indicate the information to be indicated by indicating other information, where there is an association relationship between this other information and the information to be indicated. It is also possible to indicate only part of the information to be indicated, and the other parts of the information to be indicated are known or agreed in advance. For example, the indication of the information to be indicated can be realized by pre-agreement (such as protocol stipulation) whether there is an information element, so as to reduce the indication overhead to a certain extent.

Third, the “protocol” refers to in the embodiments of this application may be a standard protocol in the field of communication, for example, it may include long term evolution (LTE) protocol, new radio (NR) protocol and related protocols in future communication systems, and this application is not limited to this.

Fourth, “pre-definition” or “pre-configuration” may be achieved by pre-storing the corresponding code, form or other means indicating relevant information in a device (for example, terminal or BS), and this application does not restrict the specific implementation method. “Store” may mean saved in one or more memories, which may be a separate setting or integrated in the processor or communication device. The one or more memories may also be partially set up separately and partially integrated in the processor or communication device. The type of memories may be any form of storage medium, and this application is not limited to this.

Fifth, “at least one” means one or more, and “multiple” means two or more. “And/or” refers to the association relationship of associated objects, indicating that there can be three relationships, for example, A and/or B, which can represent the situation that A exists alone, B exists alone, and A and B exist simultaneously, where A and B can be a single object or multiple objects. The character “/” generally indicates that the associated object is an “or” relationship. “At least one of the following items (items)” or a similar expression means any combination of these items, including any combination of single or complex items (items). For example, at least one term(s) of a, b, and c can be expressed as a, or, b, or, c, or, a and b, or, a and c, or, b and c, or, a, b, and c. Where a, b, and c can be a single object or multiple objects, respectively.

Sixth, in the embodiments of this application, “when . . . ”, “at the time of . . . ”, “in the case of . . . ”, and “if” all refer to an objective circumstance in which a device (for example, terminal or BS) will make the corresponding processing. They d₀ not limit the time, nor d₀ they require the device to have a judgment action in the implementation, nor d₀ they imply other restrictions.

Seventh, in each embodiment of the application, if there are no special instructions and logical conflicts, the terms and/or descriptions between different embodiments are consistent and can be referred to each other, and the technical features in different embodiments can be combined to form a new embodiment according to their internal logical relationships. The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. In view of the foregoing description it will be evident to a person skilled in the art that various modifications may be made within the scope of the application.

Eighth, although this disclosure refers to illustrative embodiments, this is not intended to be construed in a limiting sense. The description and drawings are, accordingly, to be regarded simply as an illustration of some embodiments of the application as defined by the appended claims, and are contemplated to cover any and all modifications, variations, combinations or equivalents that fall within the scope of the present application. Therefore, although embodiments and potential advantages have been described in detail, various changes, substitutions and alterations can be made herein without departing from the application as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present application, processes, machines, manufacture, compositions of matter, means, methods, or steps, presently existing or later to be developed, that perform substantially the same function or achieve substantially the same result as the corresponding embodiments described herein may be utilized according to the present application. Accordingly, the appended claims are intended to include within their scope such processes, machines, manufacture, compositions of matter, means, methods, or steps.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

### ACRONYMS, ABBREVIATIONS, AND INITIALISMS

| Full Name | Acronym/Abbreviation/Initialism |
|---|---|
| Long Term Evolution | LTE |
| New Radio | NR |
| Forward error correction | FEC |
| Multiple Access | MA |
| Quality of Service | QoS |
| low-density parity check codes | LDPC |
| cyclic redundancy check | CRC |
| ultra-reliable low latency | URLLC |
| communications | |
| Enhanced mobile broadband | eMBB |
| massive Machine Type | mMTC |
| Communications | |
| non-terrestrial networks | NTN |
| Internet of Things | IoT |
| Bit Error Rate | BER |
| Block Error Rate | BLER |
| Packet Error Rate | PER |
| Spectral Efficiency | SE |
| Hybrid automatic repeat request | HARQ |
| Channel Quality Indicator | CQI |
| Modulation Coding Scheme | MCS |
| gNodeB or 5G base station | gNB |
| user equipment | UE |
| Radio Resource Control | RRC |
| Radio Network Temporary Identifier | RNTI |
| Uplink Control Information | UCI |
| Downlink Control Information | DCI |
| Physical Broadcast Channel | PBCH |
| Half-radio frame bit | HRF |
| Synchronization Signal Block | SSB |
| unequal error protection | UEP |
| variable node | VN |
| check node | CN |
| Log-likelihood ratio | LLR |

What is claimed is:

1. A method comprising:
obtaining N coded bits, wherein N is a positive integer;
obtaining a first bit set, wherein the first bit set comprises at least one information bit;
determining C target code blocks (CBs) according to the N coded bits and the first bit set, wherein the C target CBs comprise M coded bits from the N coded bits and one or more bits from the first bit set, M is a positive integer less than or equal to N, and C is an integer greater than 1; and
transmitting the C target CBs.

2. The method of claim 1, further comprising:
determining the M coded bits from the N coded bits, wherein M is greater than 1.

3. The method of claim 2, wherein the M coded bits comprise C bit sets, and any one of the C bit sets comprises M/C bits.

4. The method of claim 2, wherein the N coded bits comprise a first bit sequence, the M coded bits comprise C bit sequences, and a starting point of each of the C bit sequences is a starting point of a redundancy version of the first bit sequence.

5. The method of claim 1, wherein the N coded bits comprise S coded bit sets, Sis an integer greater than 1, and the method further comprises:
determining S bit subsets from the S coded bit sets, the S bit subsets comprise the M coded bits, and M is greater than 1.

6. A method comprising:
receiving R coded bits, wherein R is a positive integer;
determining N coded bits according to the R coded bits, wherein N is a positive integer greater than or equal to R;
receiving C target code blocks (CBs), wherein C is an integer greater than 1; and
determining M coded bits and a first bit set from the C target CBs, wherein the N coded bits comprise the M coded bits, and the first bit set comprises at least one information bit.

7. The method of claim 6, wherein the M coded bits comprise C bit sets, and each of the C bit sets comprises M/C bits.

8. The method of claim 6, wherein the N coded bits comprise a first bit sequence, the M coded bits comprise C bit sequences, and a starting point of each of the C bit sequences is a starting point of a redundancy version of the first bit sequence.

9. The method of claim 6, wherein the N coded bits comprise S coded bit sets, the S coded bit sets comprise S bit subsets, the S bit subsets comprise the M coded bits, S is an integer greater than 1, and M is greater than 1.

10. The method of claim 9, wherein each of the S bit subsets comprises M/S bits.

11. An apparatus comprising:
at least one processor; and
at least one memory coupled to the at least one processor and storing instructions that, when executed by the at least one processor, cause the apparatus to perform operations including:
obtaining N coded bits, wherein N is a positive integer;
obtaining a first bit set, wherein the first bit set comprises at least one information bit; and
determining C target code blocks (CBs) according to the N coded bits and the first bit set, wherein the C target CBs comprise M coded bits from the N coded bits and one or more bits from the first bit set, M is a positive integer less than or equal to N, and C is an integer greater than 1; and
transmitting the C target CBS.

12. The apparatus of claim 11, wherein the instructions further cause the apparatus to perform:
determining the M coded bits from the N coded bits, wherein M is greater than 1.

13. The apparatus of claim 12, wherein the M coded bits comprise C bit sets, and each of the C bit sets comprises M/C bits.

14. The apparatus of claim 12, wherein the N coded bits comprise a first bit sequence, the M coded bits comprise C bit sequences, and a starting point of each of the C bit sequences is a starting point of a redundancy version of the first bit sequence.

15. The apparatus of claim 11, wherein the N coded bits comprise S coded bit sets, Sis an integer greater than 1, and the instructions further cause the apparatus to perform:
determining S bit subsets from the S coded bit sets, the S bit subsets comprise the M coded bits, and M is greater than 1.

16. An apparatus comprising:
at least one processor; and
at least one memory coupled to the at least one processor and storing instructions that, when executed by the at least one processor, cause the apparatus to perform operations including:
receiving R coded bits, wherein R is a positive integer;
determining N coded bits according to the R coded bits, wherein N is a positive integer greater than or equal to R;
receiving C target code blocks (CBs), wherein C is an integer greater than 1; and
determining M coded bits and a first bit set from the C target CBs, wherein the N coded bits comprise the M coded bits, and the first bit set comprises at least one information bit.

17. The apparatus of claim 16, wherein the M coded bits comprise C bit sets, and each of the C bit sets comprises M/C bits.

18. The apparatus of claim 16, wherein the N coded bits comprise a first bit sequence, the M coded bits comprise C bit sequences, a starting point of each of the C bit sequences is a starting point of a redundancy version of the first bit sequence.

19. The apparatus of claim 16, wherein the N coded bits comprise S coded bit sets, the S coded bit sets comprise S bit subsets, the S bit subsets comprise the M coded bits, Sis an integer greater than 1, and M is greater than 1.

20. The apparatus of claim 19, wherein each of the S bit subsets comprises M/S bits.
